(19) United States
(12) Patent Application Publication
(10) Pub. No.: US 2025/0068130 A1
(43) Pub. Date: Feb. 27, 2025

(54) ANTENNA

(71) Applicant: Apple Inc., Cupertino, CA (US)

(72) Inventors: Nathanial E. Verdonk, Cupertino, CA (US); Daniela M. Deschamps, Palo Alto, CA (US); Devon K. Copeland, San Francisco, CA (US); Nicholas L. Qu, Vancouver (CA)

(21) Appl. No.: 18/788,882

(22) Filed: Jul. 30, 2024

Related U.S. Application Data
(60) Provisional application No. 63/578,661, filed on Aug. 24, 2023.

(51) Int. Cl. G04G 17/04; G04G 17/08; H01Q 1/27

(52) U.S. Cl. CPC G04G 17/04; G04G 17/08; H01Q 1/273

(57) ABSTRACT

An electronic watch can include a housing sidewall defining an internal volume. The electronic watch can include a printed circuit board (PCB) disposed within the internal volume. The electronic watch can include an electrically conductive connector contacting the PCB. The electronic watch can include an elongate conductive member disposed along a portion of a perimeter of the housing sidewall. The elongate conductive member can include a first contact feature electrically coupling the elongate conductive member and the electrically conductive connector at a first position along a length of the elongate conductive member. The first contact feature can include a bulge. The elongate conductive member can include a second contact feature electrically coupling the elongate conductive member and the housing sidewall at a second location along the length of the elongate conductive member.

### CROSS-REFERENCE TO RELATED APPLICATION(S)

This application claims the benefit priority to U.S. Provisional Patent Application No. 63/578,661, filed 24 Aug. 2023, and entitled “ANTENNA,” the entire disclosure of which is hereby incorporated by reference in its entirety.

### FIELD

The present disclosure relates generally to electronic devices. More particularly, the present disclosure relates to wearable electronic devices.

### BACKGROUND

Electronic devices are increasingly being designed with device portability in mind to allow users to use these devices in a wide variety of situations and environments. In the context of wearable devices, these devices can be designed to include many different functionalities and to be operated in many different locations and environments. The components of an electronic device, for example the processors, memory, antennas, display, and other components, can partially determine a level of performance of the electronic device. Further, the arrangement of these components with respect to one another in the device can also determine the level of overall performance of the electronic device.

Continued advances in electronic devices and their components have enabled considerable increases in performance. Existing components and structures for electronic devices can, however, limit the levels of performance of such devices. For example, while some components can achieve high levels of performance in some situations, the inclusion of multiple components in devices sized to enhance portability can limit the performance of the components and thus the performance of the device. Consequently, further tailoring an arrangement of components for electronic devices to provide additional or enhanced functionality, without introducing or increasing undesirable device properties, can be desirable.

### SUMMARY

In one example of the present disclosure, an electronic watch can include a housing sidewall defining an internal volume. The electronic watch can include a printed circuit board (PCB) disposed within the internal volume. The electronic watch can include an electrically conductive connector contacting the PCB. The electronic watch can include an elongate conductive member disposed along a portion of a perimeter of the housing sidewall. The elongate conductive member can include a first contact feature electrically coupling the elongate conductive member and the electrically conductive connector at a first position along a length of the elongate conductive member. The first contact feature can include a bulge. The elongate conductive member can include a second contact feature electrically coupling the elongate conductive member and the housing sidewall at a second location along the length of the elongate conductive member.

In at least one example, the bulge extends toward the PCB.

In at least one example, the elongate conductive member further includes a third contact feature electrically coupling the elongate conductive member and the electrical connector at a third position along the length of the elongate conductive member. The elongate conductive member further includes a fourth contact feature electrically coupling the elongate conductive member and the housing sidewall at a fourth location along the length of the elongate conductive member.

In at least one example, the elongate conductive member includes a first end and a second end opposite the first end. The first end and the second end are coupled to the housing sidewall.

In at least one example, the elongate conductive member is coupled to the housing sidewall at a third position along the length of the elongate conductive member.

In at least one example, the housing sidewall includes a conductive upper portion, a conductive lower portion, and an insulating middle portion between the conductive upper portion and the conductive lower portion.

In at least one example, the electronic watch further includes an antenna having a radiating element and a grounding element. The radiating element includes the conductive upper portion. The grounding element includes the conductive lower portion.

In at least one example, the conductive upper portion defines an opening. The electronic watch further includes a display assembly disposed within the opening. The conductive upper portion surrounds a perimeter of the display assembly and extends above the display assembly.

In at least one example, the electronic watch further includes a seal disposed around the perimeter of the housing sidewall between the conductive lower portion and the display assembly. The seal can define a depression at the first position corresponding to the first contact feature.

In one example of the present disclosure, an antenna assembly can include a housing defining an internal volume. The housing can include an upper housing portion and a lower housing portion electrically isolated by a middle housing portion. The antenna assembly can include printed circuit board (PCB) disposed within the internal volume. The antenna assembly can include an elongate conductive member disposed along a portion of an inner perimeter of the upper housing portion. The elongate conductive member can include a first protrusion electrically contacting the PCB at a first location along a length of the elongate conductive member. The first protrusion can include a tensioning arm. The elongate conductive member can further include a second protrusion contacting the upper housing portion at a second location along the length of the elongate conductive member.

In at least one example, the antenna assembly can further include an electrical conductor creating a conductive path coupled to the PCB and contacting the first protrusion at the first location.

In at least one example, the first protrusion further includes a bulge extending toward the PCB and away from the housing.

In at least one example, the first protrusion and the second protrusion extend from the elongate conductive member in opposite directions.

In at least one example, the antenna assembly further includes a seal disposed around a perimeter of a housing and defining a depression corresponding to the first protrusion.

In at least one example, the antenna assembly further includes display module coupled to the PCB and disposed within an opening defined by the upper housing portion, wherein the elongate conductive member is disposed between the upper housing portion and the display module.

In at least one example the antenna assembly further includes a radiating element including the upper housing portion. The antenna assembly further includes a grounding element including the lower housing portion.

In one example of the present disclosure, an electronic device can include a conductive housing defining an internal volume. The electronic device can further include a printed circuit board (PCB) disposed within the internal volume. The electronic device can further include a spacer disposed along a first portion of an inner perimeter of the conductive housing sidewall. The electronic device can further include a conductive band disposed along a second portion of the inner perimeter of the conductive housing sidewall. A first end of the conductive band is removably coupled to the conductive housing sidewall at a first position along the spacer. A second of the conductive band is removably coupled to the conductive housing sidewall at a second position along the spacer.

In one example, the spacer includes a first feature to receive the first end of the conductive band and a second feature to receive the second end of the conductive band.

In one example, the conductive band includes a first plurality of bulges disposed along a length of the conductive band and forming electrical connections with the PCB. The conductive band also includes a second plurality of bulges disposed along the length of the conductive band and forming electrical connects with the conductive housing sidewall.

In one example, the electronic device further includes an antenna having a radiating element and a grounding element. The radiating element includes an upper portion of the conductive housing sidewall. The grounding element includes a lower portion of the conductive housing sidewall.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows an example of an electronic device, according to one example;

FIG. 1B illustrates the electronic device, for example a smartwatch or an electronic watch, that can be substantially similar to and can include some or all of the features of the devices described herein, including the electronic device shown in FIG. 1A but without the strap;

FIG. 1C shows a bottom perspective view of the electronic device.

FIG. 2A illustrates a right perspective view of an electronic watch including a housing with housing sidewalls, according to one example;

FIG. 2B illustrates a left perspective view of the electronic watch including the housing with housing sidewalls, according to one example;

FIG. 2A illustrates an exploded view of the electronic watch of FIGS. 2A-2B, according to one example;

FIG. 2D illustrates an exploded view of the housing and the display assembly of the electronic watch, according to one example;

FIG. 3A illustrates a housing sidewall and an elongate conductive member (ECM) of an electronic device, according to one example;

FIG. 3B illustrates the ECM including contact features, according to one example;

FIG. 4 illustrates contact points between an ECM and a housing sidewall, and contact points between the ECM and a PCB of an electronic device, according to one example;

FIG. 5A illustrates a cross-sectional view of the electronic device at a first location where the ECM electrically contacts the upper portion of the housing sidewall, according to one example;

FIG. 5B illustrates a cross-sectional view of the electronic device at a second location where the ECM electrically contacts the PCB, according to one example;

FIG. 5C illustrates a cross-sectional view of the electronic device at a third location, where the ECM electrically contacts neither the upper housing portion nor the PCB, according to one example;

FIG. 6A illustrates a portion of an ECM of an electronic device, according to one example;

FIG. 6B illustrates a first perspective view of a protrusion of the ECM of the electronic device, according to one example;

FIG. 6C illustrates a second perspective view, opposite the first perspective view, of the protrusion of the ECM of the electronic device, according to one example;

FIG. 7A illustrates a portion of an ECM of an electronic device, according to one example;

FIG. 7B illustrates a first perspective view of a protrusion of the ECM of the electronic device, according to one example;

FIG. 7C illustrates a second perspective view, opposite the first perspective view, of the protrusion of the ECM of the electronic device, according to one example;

FIG. 8A illustrates a perspective view of a portion of an electronic device with a spacer coupling an ECM to a sidewall of a housing of the electronic device, according to one example;

FIG. 8B illustrates a zoomed-in perspective view of the region of the electronic device, according to one example;

FIG. 8C illustrates a zoomed-in top view of the region of the electronic device, according to one example;

FIG. 9A illustrates a first perspective view of a spacer of an electronic device, according to one example;

FIG. 9B illustrates a second perspective view of the spacer of the electronic device, according to one example;

FIG. 10A illustrates a first perspective view of a spacer of an electronic device, according to one example;

FIG. 10B illustrates a second perspective view of the spacer of the electronic device, according to one example;

FIG. 11A illustrates an exploded view of an electronic device including an ECM and seal, according to one example;

FIG. 11B illustrates a top view of the electronic device including the seal, according to one example; and

FIG. 11C illustrates a top view of a cutout, for example, the cutout in the seal or adhesive layer of the electronic device, according to one example.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure generally relates to electronic devices. More particularly, the present disclosure relates to wearable electronic devices. The wearable electronic devices of the present disclosure include tailored arrangements of components to provide additional or enhanced functionality, without introducing or increasing undesirable device properties or performance. In this way, more functionality and componentry can be included in wearable devices for users to wear and operate in any condition or activity without limiting the functionality and durability of the devices.

In one example, an electronic watch can include a housing sidewall defining an internal volume. The electronic watch can include a printed circuit board (PCB) disposed within the internal volume. The electronic watch can include an electrically conductive connector contacting the PCB. The electronic watch can include an elongate conductive member disposed along a portion of a perimeter of the housing sidewall. The elongate conductive member can include a first contact feature electrically coupling the elongate conductive member and the electronic connector at a first position along a length of the elongate conductive member. The first contact feature can include a bulge. The elongate conductive member can include a second contact feature electrically coupling the elongate conductive member and the housing sidewall at a second location along the length of the elongate conductive member. In one example, such an arrangement can allow an upper portion of the housing to act as a radiating element and a lower portion of the housing to act as a grounding element of an antenna. An increased vertical distance between the radiating element and the grounding element can improve antenna performance and stability. The elongate conductive member can electrically couple these elements of the antenna, which are formed from the structural housing (e.g., upper and lower portions noted above), thus improving antenna performance, durability, and compactness of the device.

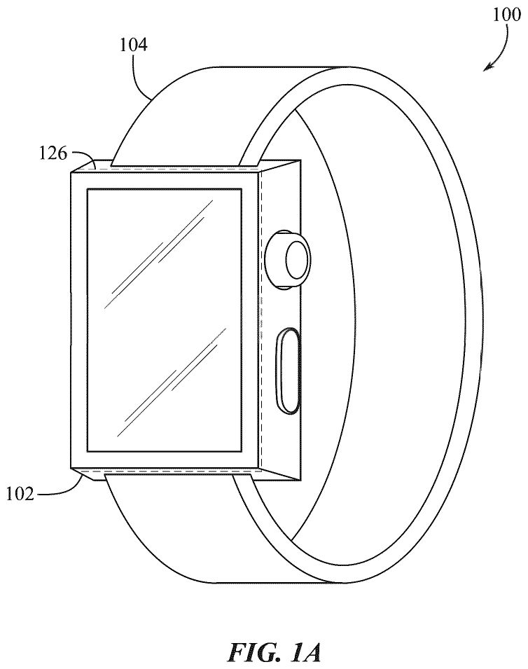

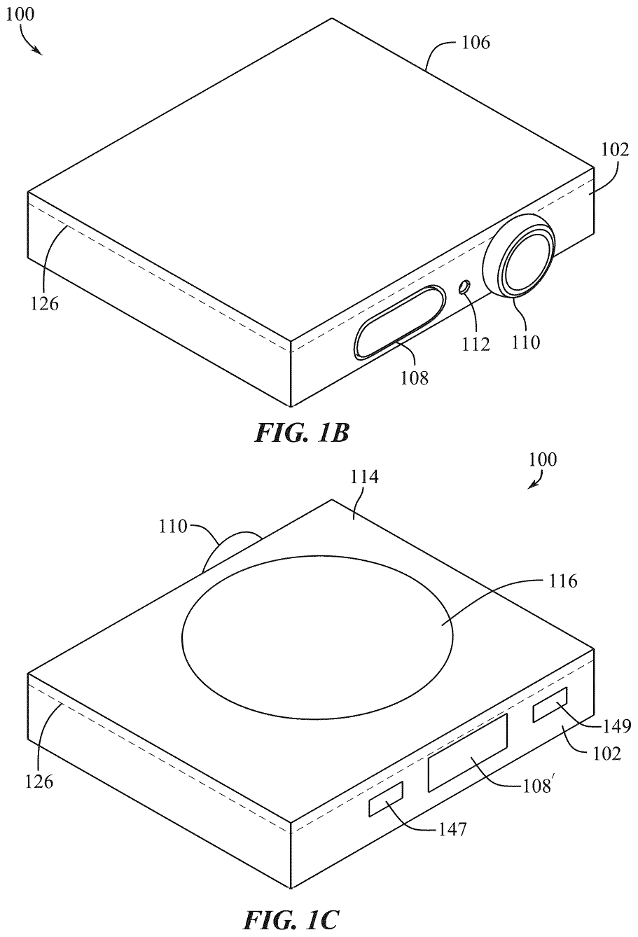

These and other examples are discussed below with reference to FIGS. 1-13.

However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A shows an example of an electronic device 100, according to one example. The electronic device shown in FIG. 1A can be a watch, such as a smartwatch or an electronic watch. The electronic device 100 of FIG. 1A is merely one representative example of a device that can be used in conjunction with the systems and methods disclosed herein. For example, the electronic device 100 can correspond to any form of wearable electronic device, a portable media player, a media storage device, a portable digital assistant (“PDA”), a tablet computer, a computer, a mobile communication device, a GPS unit, a remote-control device, or other electronic device. The electronic device 100 can also be referred to as a consumer device. In some examples, the electronic device 100 can include a housing 102 that can carry operational components, for example, in an internal volume at least partially defined by the housing 102. An elongate conductive member (ECM) 126 can be disposed within the housing 102, as will be detailed herein. The electronic device 100 can also include a strap 104, or other retaining component that can secure the electronic device 100 to a body of a user as desired. Further details of the electronic device are provided below with reference to FIG. 1B.

FIG. 1B illustrates the electronic device 100, for example a smartwatch or an electronic watch, that can be substantially similar to and can include some or all of the features of the devices described herein, including the electronic device 100 shown in FIG. 1A but without the strap 104. The device 100 can include a housing 102, and a display assembly 106 attached to the housing 102. The housing 102 can substantially define at least a portion of an exterior surface of the device 100.

The display assembly 106 can be a display module. The display assembly 106 can include a display cover. The display cover can be a glass, a plastic, or any other substantially transparent exterior layer, material, component, or assembly. The display assembly 106 can include multiple layers, with each layer providing a unique function, as described herein. Accordingly, the display assembly 106 can be, or can be a part of, an interface component. The display assembly 106 can define a front exterior surface of the electronic device 100 and, as described herein, this exterior surface can be considered an interface surface. In some examples, the interface surface defined by display assembly 106 can receive inputs, such as touch inputs, from the user.

In some examples, the housing 102 can be a substantially continuous or unitary component and can define one or more openings to receive components of the electronic device 100. In some examples, the electronic device 100 can include input components such as one or more buttons 108 and/or a crown 110 that can be disposed in the openings. In some examples, a material can be disposed between the buttons 108 and/or crown 110 and the housing 102 to provide an airtight and/or watertight seal at the locations of the openings. The housing 102 can also define one or more openings or apertures, such as aperture 112 that can allow for sound to pass into or out of the internal volume defined by the housing 102. For example, the aperture 112 can be in communication with a microphone component disposed in the internal volume. In some examples, the housing 102 can define or include a feature, such as an indentation to removably couple the housing 102 and a strap or retaining component.

FIG. 1C shows a bottom perspective view of the electronic device 100. The electronic device 100 can include a back cover 114 that can be attached to the housing 102, for example, opposite the display assembly 106. The back cover 114 can include ceramic, plastic, metal, or combinations thereof. In some examples, the back cover 114 can include an at least partially electromagnetically transparent component 116. The electromagnetically transparent component 116 can be transparent to any desired wavelengths of electromagnetic radiation, such as visible light, infrared light, radio waves, or combinations thereof. In some examples, the electromagnetically transparent component 116 can allow sensors and/or emitters disposed in the housing 102 to communicate with the external environment. Together, the housing 102, display assembly 106 and back cover 114 can substantially define an internal volume and an external surface of the device 100.

As noted above, portable and/or wearable electronic devices can be designed for use in many different environments and during any kind of activity throughout a user's day. For example, wearable electronic watches, headphones, and phones can be carried by a user during exercise, sleep, driving, biking, hiking, swimming, diving, outside in the rain, outside in the sun, and so forth. Wearable electronic devices described herein are configured to withstand the varied and often harsh conditions of various environments, including changing environments and wet environments. Wet environments can include wearing devices in the rain or when submerged during bathing or swimming, for example. Such devices transmit and/or receive signals via an antenna of the electronic device. Accordingly, there is need for the antenna to function consistently and reliably. As described herein, the ECM 126 can provide such functionality.

Examples of electronic devices disclosed herein include components, features, arrangements, and configurations that resists damage and corrosion due to exposure to moisture. Some aspects of devices described herein can include gaps between components through which moisture, water, or other fluids could enter. The gaps may be present for aesthetic purposes or for functional purposes. However, one or more components, including seals (such as pressure-sensitive adhesives (PSAs)), insulating materials and frames, and other components of devices described herein can be configured to prevent such moisture from entering the internal volume of the device where sensitive electronic component could be damaged thereby.

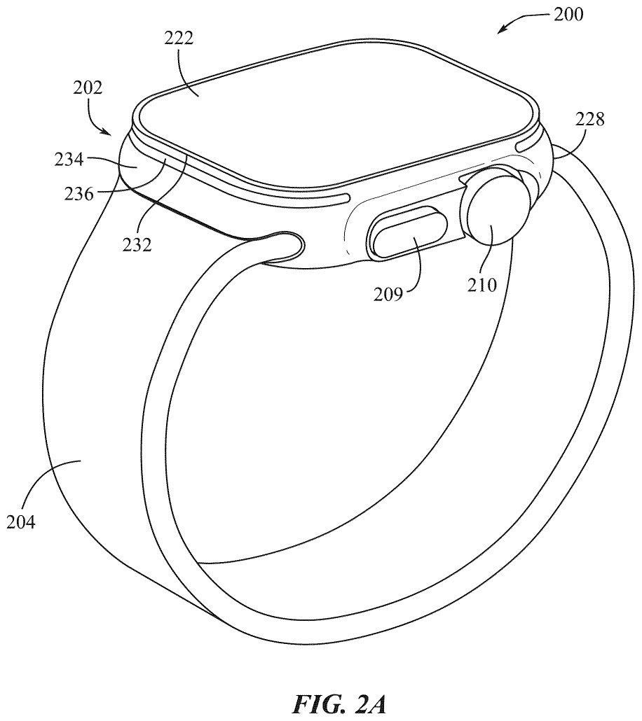

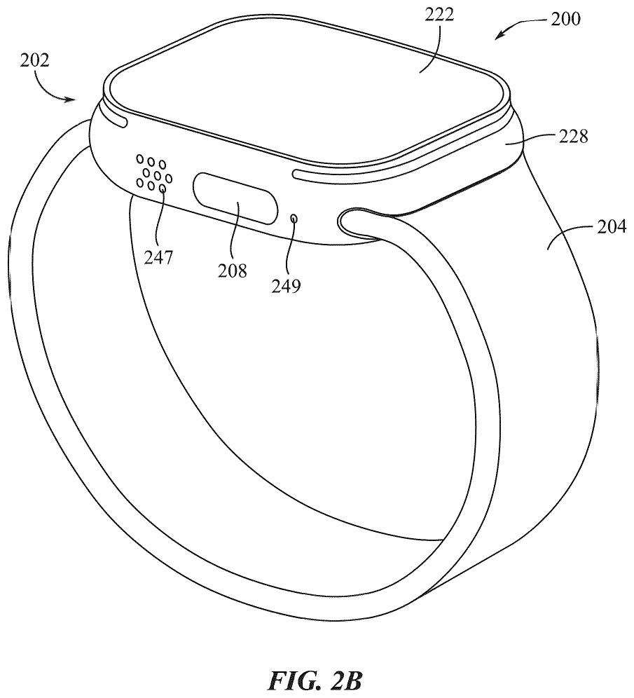

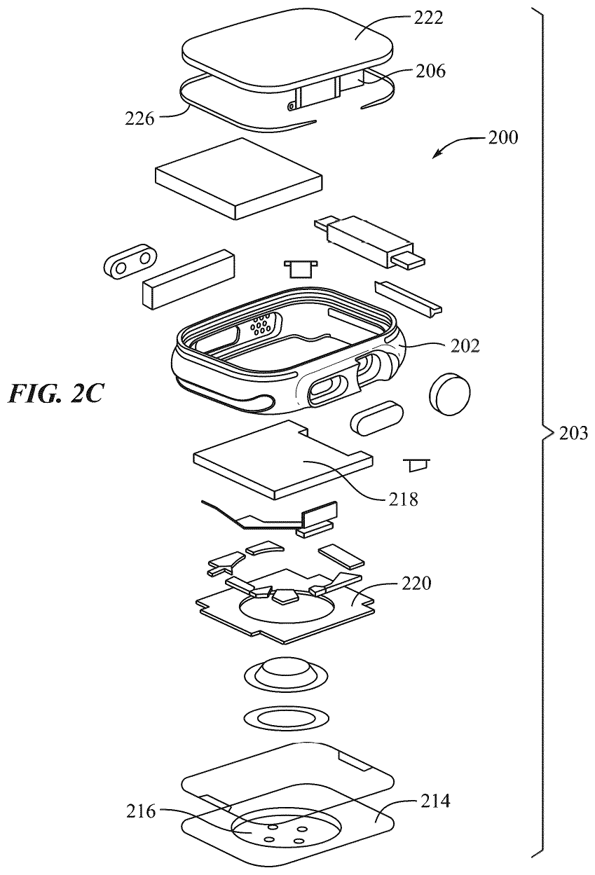

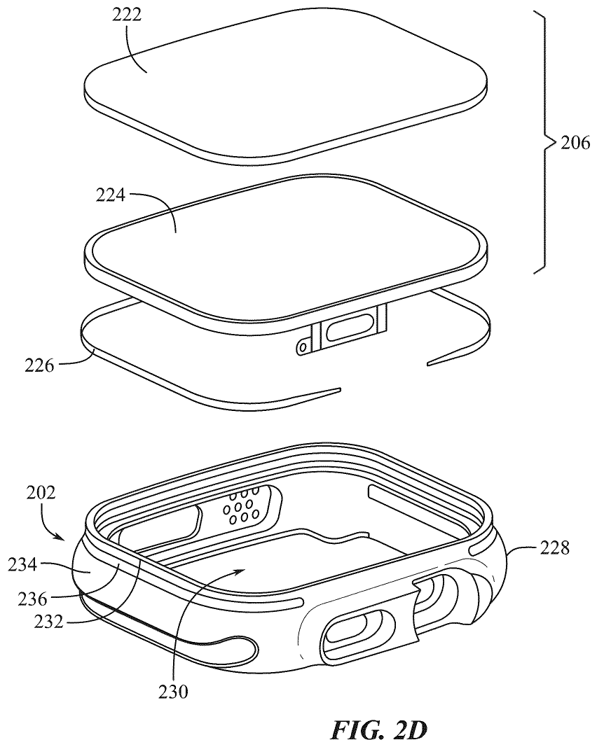

Any of the features, components, and/or parts, including the arrangements and configurations thereof shown in FIGS. 1A-1C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1A-1C. Additional details of the electronic device are provided below with reference to FIGS. 2A-2B.

FIGS. 2A-2B illustrate right and left perspective views, respectively, of an electronic watch 200 including a housing 202 with housing sidewalls 228, according to one example. In some examples, the electronic device 200 can be a smartwatch. The sidewalls 228 can define an opening in which a display cover 222 is disposed. The electronic watch 200 can include a securement strap 204 configured to secure the electronic watch 200 to an appendage of the user.

The sidewalls 228 can define an upper peripheral edge of the electronic watch 200, which surrounds the display cover 222. In particular, the sidewalls 228 can include an upper portion 232, a lower portion 234, and a middle portion 236. The upper portion 232 can define an upper peripheral edge surround the display cover 222. The middle portion 236 can be disposed between the upper portion 232 and the lower portion 234.

In at least one example, the display cover 222 defines a top surface disposed in a plane. The plane can be flush with or set below the upper peripheral edge of the sidewalls 228. In this way, when the wearable electronic device 200 contacts a surface or object at or near the upper surface of the display cover 222 and/or the upper peripheral edge of the sidewalls 228, contact and potential damage to the display cover 222 can be reduced. In one example, the display cover 222 is set flush with or below the upper peripheral edges of the sidewalls 228 to protect the display cover 222 from damage.

In at least one example, as shown in FIG. 2A, the sidewalls 228 can define a first side of the electronic watch 200 having a recessed feature in which a crown 210 is positioned. The crown 210 can be a part of a turn dial button or other functional knob configured to be manipulated by the user. The crown 210 can be disposed in the recessed portion, as noted above, such that first side of the sidewalls 228 extend outward and at least partially around the crown 210. In this way, contacts and bumps against of other objects against the first side of the sidewall 228 during use can contact the sidewall 228 without pressing or turning the crown 210. In this way, the recessed portion of the first side of the sidewalls 228 prevents inadvertent manipulation of the crown 210. The button 209 shown in FIG. 2A can also be at least partially surrounded by an outwardly extending portion of the sidewall 228, such that the button 209 is disposed within a recess thereof, to protect the button 209 form inadvertent contacts.

In at least one example, as shown in FIG. 2B, the sidewalls 228 can define a second side opposite the first side shown in FIG. 2A. In such an example, the wearable electronic device 200 can include a first speaker vent 247, a second speaker vent 249, and a button 208 disposed between the first speaker vent 247 and the second speaker vent 249. The first speaker vent 247 and second speaker vent 249 can provide fluid communication from a common speaker volume behind the sidewall 228 (e.g., within an internal volume defined by the sidewalls 228) and the external environment. The button 208 can be disposed between the first speaker vent 247 and the second speaker vents 249 to save space and provide a compact design without interrupting the functionality of the one or more speakers communicating with the external environment through the first speaker vent 247 and the second speaker vent 249.

The electronic watch 200 includes a display assembly 206, which includes the display cover 222. The electronic watch 200 includes the housing 202, a back cover 214, and an electromagnetically transparent component 216. The housing 202, the back cover 214, the electromagnetically transparent component 216, and the display cover 222 can define an internal volume 203. In at least one example, the housing sidewalls 228 define the internal volume 203.

In addition, the exploded view of FIG. 2C illustrates various internal components that can be disposed within the internal volume 203. For example, the electronic watch 200 can include one or more printed circuit boards (PCBs) 218 and one or more antenna components 220, as well as electrical connectors and flexes, buttons, seals, gaskets, memory components, processors, sensors, dials, batteries, and so forth disposed within the internal volume 203.

FIG. 2D illustrates an exploded view of the housing 202 and the display assembly 206 of the electronic watch 200, according to one example. As depicted in FIG. 2D, the display assembly 206 is further exploded to illustrate the display cover 222 and display layers 224. In addition, FIG. 2D illustrates an ECM 226. In at least one example, the ECM 226 is a wave ring. A wave ring can refer to an example of an ECM in which electrical contacts can be made between the housing and the PCB as resulting from an undulation or circumferential variation (e.g., wave). The ECM 226 will be described and discussed in more detail hereafter with reference to other figures.

The housing 202 defines an opening 230 and at least partially defines the internal volume. In particular, the upper portion 232 of the sidewall 228 can define the opening 230. When assembled, the display assembly 206 and/or one of the components of the display assembly 206 can be disposed in the opening 230 to form an outer surface of the electronic watch 200 and at least partially define the internal volume.

In at least one example, the sidewall 228 can include an upper portion 232 and a lower portion 234. The upper portion 232 and the lower portion 234 can be separated by a middle portion 236 disposed between the upper portion 232 and the lower portion 234. In at least one example, the upper portion 232 and the lower portion 234 of the sidewall 228 can include one or more electrically conductive materials and the middle portion 236 can include one or more electrically non-conductive materials (e.g., an insulating material). The middle portion 236 can be molded to or otherwise adhered to the upper portion 232 and/or the lower portion 234 such that the upper portion 232, the lower portion 234, and the middle portion 236 form a single, unitary sidewall 228 of the housing 202, as shown.

As will be described in relation to the ECM 226, the electronic device 200 can include an antenna wherein the upper portion 232 of the conductive housing 228 forms a radiating element of the antenna and the lower portion 234 of the conductive housing forms a grounding element of the antenna.

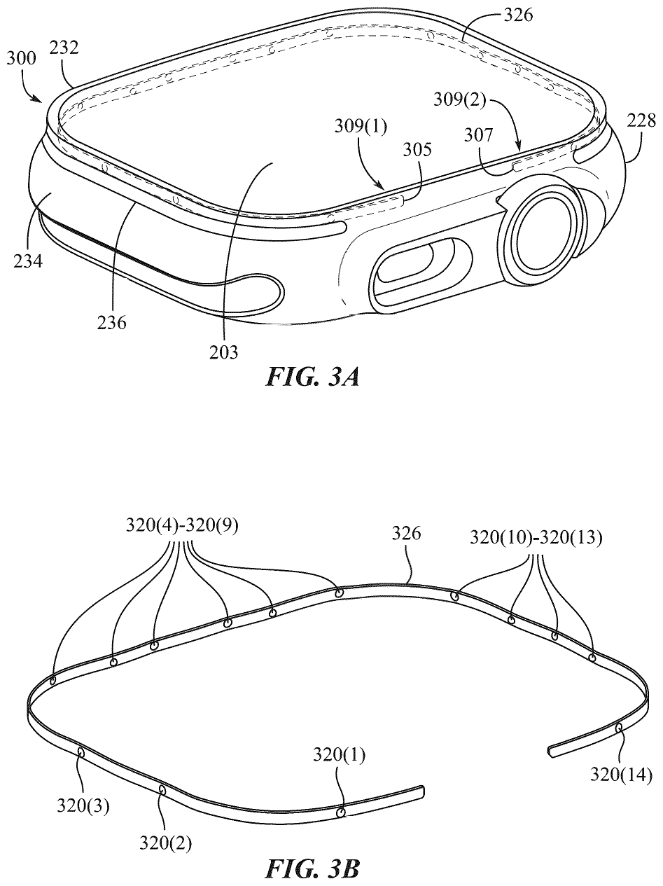

Any of the features, components, and/or parts, including the arrangements and configurations thereof shown in FIGS. 2A-2D can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A-2D. Additional details of the display assembly 206 are provided in reference to FIG. 3.

FIG. 3A illustrates a housing sidewall 228 and an ECM 326 of an electronic device 300, according to one example. Although not all components may be shown, the electronic device 300 can be substantially similar to the electronic watch 200 of FIG. 2 and other electronic devices described herein, as noted by the same or similar reference numbers.

The housing sidewall 228 can include an upper housing portion 232, a lower housing portion 234, and a middle housing portion 236. The upper housing portion 232 and the lower housing portion 234 can be electrically isolated by the middle housing portion 236. In other words, the housing sidewall 228 includes a conductive upper portion (the upper housing portion 232), a conductive lower portion (the lower housing portion 234), and an insulating middle portion (the middle housing portion 236) between the conductive upper portion and the conductive lower portion.

The ECM 326 can be disposed along a portion of a perimeter of the housing sidewall 228. More specifically, the ECM 326 can be disposed along a portion of an inner perimeter of the upper housing portion 232. In at least one example, the ECM 326 includes a gap, such that the ECM 326 is only partially disposed along the inner perimeter of the upper housing portion 232. As used herein, a gap indicates a discontinuity, such that the ECM 326 does not form a continuous ring.

In at least one example, a first end 305 and a second end 307 of the ECM 326 are coupled to the housing sidewall 228. The first end 305 and the second end 307 can be mechanically coupled to the inner perimeter of the upper housing portion 232 at a first contact point 309(1) and a second contact point 309(2). The first end 305 and the second end 307 can be coupled via a weld process or other mechanism (snap connections or other non-permanent connections). In at least one example, at the first contact point 309(1), the first end 305 of the ECM 326 is electrically coupled to the upper housing portion 232; and at the second contact point 309(2), the second end 307 of the ECM 326 is electrically coupled to the upper housing portion 232. In a further example, the ECM 326 and the upper housing portion 232 can be mechanically and electrically coupled at additional contact points (e.g., via welds or other mechanisms). For example, the ECM 326 can be coupled to the housing sidewall 228 along a third position along the length of the ECM 326. The third position can be another weld point or other type of coupling between the first contact point 309(1) and the second contact point 309(2), and along the ECM 326.

FIG. 3B illustrates the ECM 326 including contact features 320, according to one example. The ECM 326 can include a contact feature 320(1) that electrically couples the ECM 326 and the housing sidewall 228. In particular, the contact feature 320(1) can electrically contact the upper housing portion 232 of the housing sidewall 228. As depicted in FIG. 3B, the ECM 326 includes contact features 320(1)-320 (14). However, in other examples the ECM 326 can have a different number of contact features. In one example, the ECM 326 has no contact features, and only makes electrical contact with the upper housing portion 232 at the contact points 309(1) and 309(2) at the first end 305 and the second end 307, respectively, of the ECM 326. In other examples, the ECM 326 can have between one and thirteen contact features. In other examples, the ECM 326 can have more than fourteen contact features. In at least one example, the contact features 320 are spaced substantially evenly along the ECM 326.

The contact feature 320 can be a protrusion in the ECM 326 which protrudes towards the housing sidewall 228. In at least one example, the contact feature 320 can be a bump or dimple and can be referred to as a micro-dimple. In one example, the contact feature 320 can have a substantially half sphere profile. In other examples, the contact feature 320 can have a conical profile, a rectangular profile, or other suitable profile which protrudes towards the housing sidewall 228 to make electrical contact with the housing sidewall 228 at a given location. In at least one example, some or all of the contact features 320 can be permanent (e.g., the contact features 320 can be welded to the housing sidewall 228). In at least one example, permanently welding the contact features 320 to the housing sidewall 228 can help ensure grounding of the ECM 326 to the housing sidewall 228 at each point of contact.

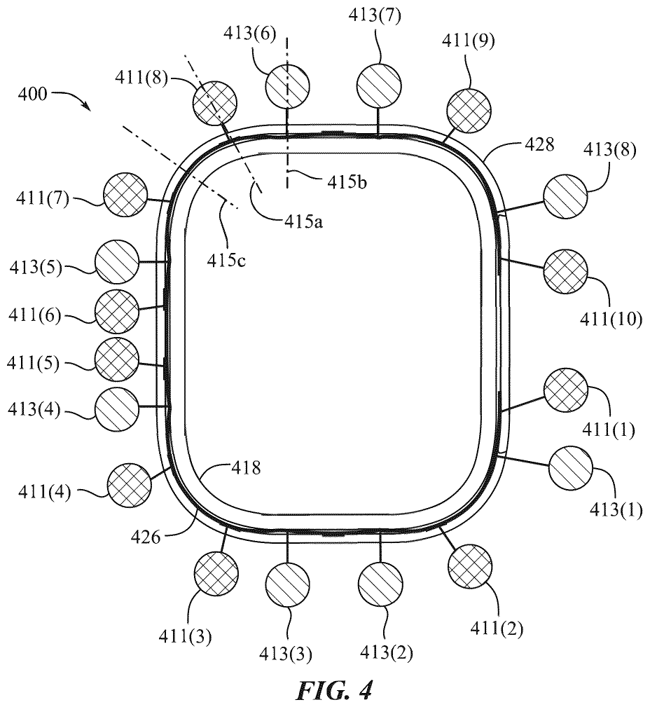

Any of the features, components, and/or parts, including the arrangements and configurations thereof shown in FIGS. 3A-3B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 3A-3B. Additional details of contact points between the ECM and other components of the electronic device are provided in reference to FIG. 4.

FIG. 4 illustrates contact points 411(1)-(10) between an ECM 426 and a housing sidewall 428, as well as contact points 413(1)-(8) between the ECM 426 and a PCB 418 of an electronic device 400, according to one example. In one example, the contact points 413 are between the ECM 426 and a conductive member in contact with the PCB 418. The PCB 418 can be disposed within the internal volume of the electronic device 400. The contact points 411 correspond to locations at which the ECM 426 and the housing sidewall 428 are electrically coupled. In particular, the contact points 411 correspond to locations at which the ECM 426 and the upper housing portion (e.g., the upper housing portion 232) of the sidewall 428 are coupled. The contact points 413 correspond to locations at which the ECM 426 and the PCB 418 are electrically coupled. In at least one example, the ECM 426 can include a first plurality of bulges (at contact points 413) forming electrical connections with the PCB 418; and the ECM 426 can include a second plurality of bulges (at contact points 411) forming electrical connections with the conductive housing sidewall 428. In at least one example, rather than including bulges, an ECM can have undulations and/or circumferential variations (e.g., waves) to form electrical connections with the PCB 418 and/or the conductive housing sidewall 428. In additional or alternative examples, an ECM can have both waves and bulges. In such a way, the electronic device 400 includes an antenna in which an upper portion of the housing sidewall 428 forms a radiating element of the antenna and a lower portion of the housing sidewall 428 forms a grounding element of the antenna.

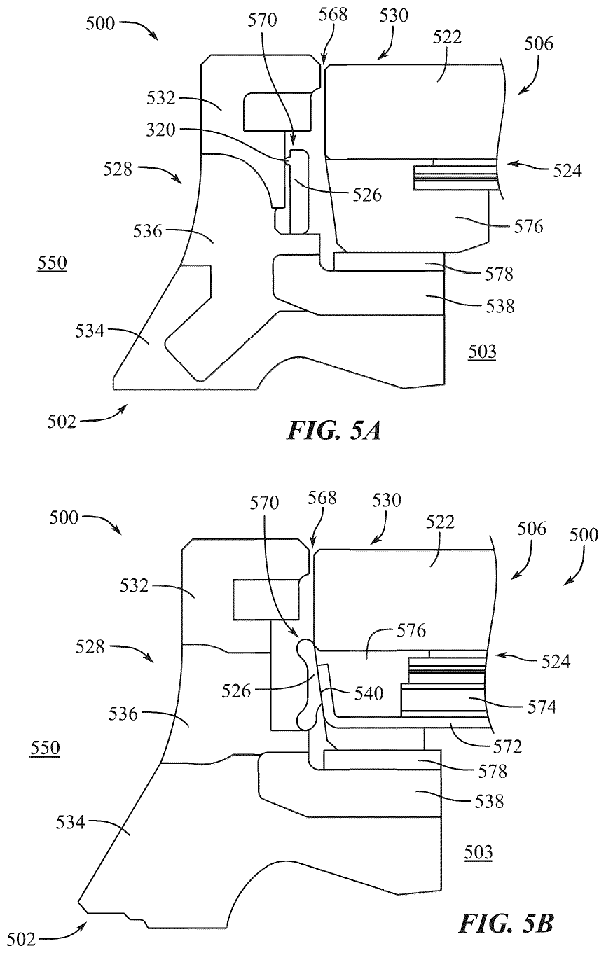

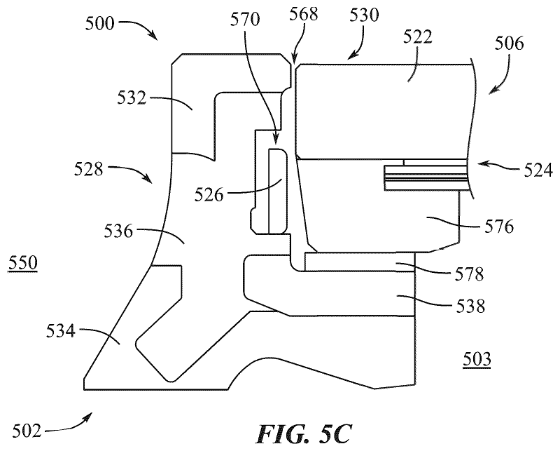

Details of the ECM 426 to sidewall 428 coupling are provided below with respect to FIG. 5B. Details of the ECM 426 to PCB 418 coupling are provided below with respect to FIG. 5C. Regions where the ECM 426 is not coupled to the sidewall 428 or the PCB 418 are provided below with respect to FIG. 5A.

In at least one example, the contact points 411 and the contact points 413 are at least partially alternated such that they are distributed substantially evenly along the ECM 426. As depicted in FIG. 4, some contact points, such as contact points 411(1), 413(1), 411(2), and 413(2) are disposed in an alternating pattern. Other contact points, such as 411(2), 413(2), 413(3), 411(3), 411(4), and 413(4) are disposed in a bi-alternating pattern. In general, the contact points 411 and 413 can be disposed in any suitable distribution pattern. The contact points 411 can be formed by the contact features 320 of FIG. 3. The contact points 413 can be formed by contact features similar to those described in reference to FIGS. 5-9.

In at least one example, the ECM 426 includes a first contact feature electrically coupling the ECM 426 and the electrically conductive connector at a first location 413(1). The electrically conductive connector can be a wire, pin, or other electrically conductive path. The electrically conductive path created by the electrically conductive connector can be coupled to the PCB and can contact the first contact feature (protrusion) at the first location 413(1). The first contact feature can be a bulge, as described in FIG. 5. The ECM 426 can include a second feature electrically coupling the ECM and the housing sidewall 428 at a second position 411(1) along the length of the ECM 426. In at least one example, the ECM 426 includes a third contact feature electrically coupling the ECM and the electrically conductive connector at a third position along the ECM 426. The ECM includes a fourth contact feature electrically coupling the ECM 426 and the housing sidewall 428 at a fourth position along a length of the ECM.

Any of the features, components, and/or parts, including the arrangements and configurations thereof shown in FIG. 4 can be included, cither alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4. Additional details of contact points between the ECM and other components of the electronic device are provided in reference to FIGS. 5A-5C.

FIGS. 5A-5C illustrate cross-sectional views of a housing sidewall 528 and an ECM 526 of an electronic device 500 along the lines 415a, 415b, and 415c of FIG. 4, according to one example. The wearable electronic devices described herein can include antennas configured to send and receive electromagnetic signals during use. Incorporating effective antennas into small, compact devices such as wearable electronic watches can be challenging because the greater the distance between a resonating plane and a grounding plane of an antenna, among other factors, the better the performance of the antenna will be. However, space is often limited to create the required Z-distances necessary in compact wearable electronic devices. In devices described herein, the housing and sidewalls of the device can be electrically separated into multiple portions to create resonating elements and grounding elements of an antenna with sufficient separation (Z-distance) for the housing itself to act as an antenna. However, this design has its own challenges, including electrically connecting the resonating element to a PCB, processor, or other electronic device without reducing the Z-distance of the antenna. Wearable electronic devices described herein are configured to overcome these challenges, as described below.

In at least one example, the electronic device 500 can include the sidewall 528 defining an internal volume 503. In at least one example, the sidewall 528 includes a conductive upper portion 532, a conductive lower portion 534, and an insulating middle portion 536. The insulating middle portion 536 can be disposed between the conductive upper portion 532 and the conductive lower portion 536. In other terms, the housing 502 defines the internal volume 503 and includes the upper housing portion 532 and the lower housing portion 534 that are electrically isolated by the middle housing portion 536. In at least one example, the middle portion 536 can be bonded to the upper portion 532 and the lower portion 534 to electrically isolate the lower portion 534 from the upper portion 532. The upper portion 532 can define an opening 530.

In at least one example, the electronic device 500 can also include a display assembly 506 disposed within the opening 530 defined by the conductive upper portion 532. In at least one example, the conductive upper portion 532 surrounds a perimeter of the display assembly 506 and extends above the display assembly 506. The display assembly 506 can include a display cover 522 and one or more other display layers 524 disposed below the display cover 522. The display assembly 506 can be disposed in the opening 530 such that a gap 568 is formed between the display assembly and the sidewall 528. The gap 568 is a space between the display assembly 506 and the sidewall 528.

In at least one example, the electronic device 500 further includes an insulating material 576, seal 538, and an adhesive layer 578 disposed between the insulating material 576 and the seal 538. The middle portion 536, the display cover 522, the insulating material 576, the seal 538, and the adhesive layer 578 can define a cavity 570. The cavity 570 can run along at least a portion of a perimeter of the electronic device 500. In particular, the cavity 570 can run along at least a portion of an inner perimeter of the sidewall 528. The cavity 570 can be in fluid communication with the external environment 550 via the gap 568.

The seal 538 can bond to other layers and components including the adhesive layer 578, the middle portion 536, the lower portion 534, and/or the insulating material 576 to prevent moisture, dust, and/or other contaminants from entering the internal volume 503 from the external environment 550. The seal 538 can in some examples be an adhesive layer or adhesive seal, such as a pressure-sensitive adhesive (PSA). In at least one example, one or more other components can be disposed or stacked between the seal 538 and the display assembly 506, for example, the adhesive layer 578. In at least one example, an epoxy layer can be stacked below the seal 538, opposite the display assembly. In addition, the insulating material 576 can support a PCB 574 (shown in FIG. 5B) disposed within the internal volume 503.

In at least one example, the electronic device 500 includes an ECM 526 similar to the ECMs 126-426 of FIGS. 1-4. In at least one example, the ECM 526 is a wave ring. The ECM 526 is disposed within the cavity 570. The ECM 526 can make electrical contact with various points of the upper housing portion 532 at contact points 411 of FIG. 4. The ECM 526 can make electrical contact with a PCB (PCB 574 of FIG. 5C) at contact points 413 of FIG. 4. At some locations with ECM 526 does not contact the upper housing portion 532 or the PCB 574.

FIG. 5A illustrates a cross-sectional view of the electronic device 500 at a first location 415a where the ECM 526 electrically contacts the upper portion 532 of the housing sidewall 228, according to one example. In particular, FIG. 5A illustrates the cross-sectional view of the electronic device 500 at a contact point 411 including a contact feature 320 of FIG. 3.

At the location 415a, the ECM 526 can include a contact feature 320. The contact feature 320 can electrically couple the ECM 526 and the housing sidewall 528 at the location 415a along a length of the ECM 526. In at least one example, the contact feature 320 can be a protrusion or a dimple (e.g., a micro-dimple) that protrudes from the ECM 526 toward the external environment 550 to contact the upper portion 532 of the housing sidewall 528.

In at least one example, the ECM 526 can include an additional contact feature 320 electrically coupling the ECM 526 and the housing sidewall 528 at an additional location along the length of the ECM 526. The ECM 526 can include multiple contact features 320 electrically coupling the ECM 526 and the housing sidewall 528, as illustrated by contact points 411.

FIG. 5B illustrates a cross-sectional view of the electronic device 500 at a second location 415b where the ECM 526 electrically contacts the PCB 574, according to one example. The electronic device 500 includes a PCB 574 disposed within the internal volume 503. In at least one example, the electronic device 500 can include an electrically conductive connector 572 extending though the insulating material 576 between the gap 568 and the PCB 574. The electrically conductive connector 572 can contact the PCB 574.

In at least one example, the upper portion 532 of the sidewall 528 can be electrically isolated from the lower portion 534 via the intermediary and non-conductive middle portion 536. In this way, the upper portion 532 can be a resonating element of an antenna of the electronic device 500 with the lower portion 534 of the sidewall 528 acting as an electrical grounding plane relative to the resonating plane of the upper portion 532. As noted above, the upper portion 532 can be electrically connected to the PCB 574 of the device 500 such that signals received and sent by the resonating upper portion 532 can be directed to the PCB 574 and can be processed with one or more processors or other electronic components of the device 500, including any processors or other electronic components mounted on the PCB.

At the location 415b, the ECM 526 includes a contact feature 540. The contact feature 540 can electrically couple the ECM 526 and the electrically conductive connector 572 at the location 415b along the length of the ECM 526. In at least one example, the contact feature 540 can be a protrusion or a bulge that protrudes from the ECM 526 toward the internal volume 503 to contact the electrically conductive connector 572. In particular, the bulge or protrusion can extend from the housing 502, the housing sidewall 528, and toward the PCB 574. In this way, the upper housing portion 532 can be electrically connected to the PCB 574 through the ECM 526.

In at least one example, the ECM 526 can include an additional contact feature 540 electrically coupling the ECM 526 and the electrically conductive connector 572 at an additional location along the length of the ECM 526. The ECM 526 can include multiple contact features 540 electrically coupling the ECM 526 and the electrically conductive connector 572, and thus the PCB 574, as illustrate by contact points 413. As can be seen in FIGS. 5A-5B, the protrusions 540 and the protrusions 320 can extend from the ECM 526 in opposite directions.

FIG. 5C illustrates a cross-sectional view of the electronic device 500 at a third location 415c, where the ECM 526 electrically contacts neither the upper housing portion 532 nor the PCB 574, according to one example. At the location 415c, the ECM 526 does not have any contact features and is disposed within the cavity 570. However, due to the electrically conductive nature of the ECM 526, the upper housing portion 532 and the PCB 574 are electrically coupled such that the upper housing portion 532 (e.g., the conductive upper portion) forms a radiating element of an antenna while the lower housing portion 534 (e.g., the conductive portion) forms a grounding element of the antenna. In other words, the sidewall 228 at least partially forms an antenna assembly, in which the radiating element of the antenna of the electronic device 500 includes the upper housing portion 532, while the grounding element of the antenna of the electronic device 500 includes the lower housing portion 534.

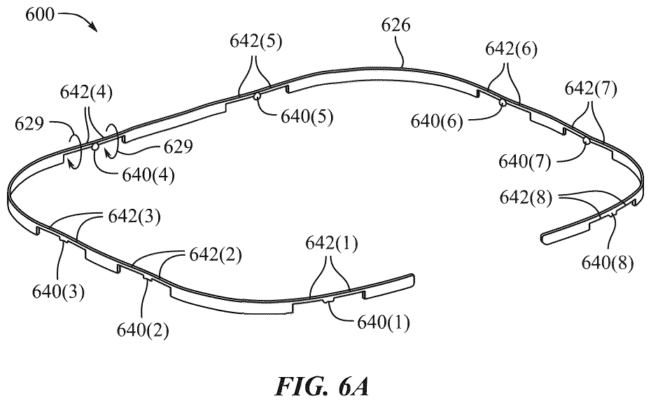

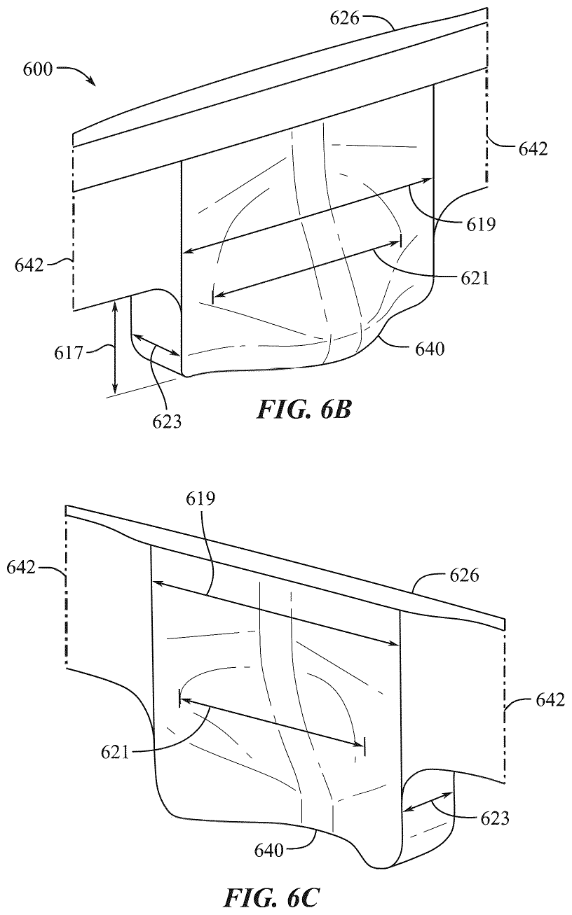

Any of the features, components, and/or parts, including the arrangements and configurations thereof shown in FIGS. 5A-5C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 5A-5C. Additional details of contact points between the ECM and the PCB are provided below in reference to FIG. 6.

FIG. 6A illustrates a portion of an ECM 626 of an electronic device 600, according to one example. Although not all of the components of the electronic device 600 are shown, the electronic device 600 can be similar to the electronic devices 100-500 of FIGS. 1-5, as noted by similar reference numbers.

The ECM 626 includes contact features 640 for electrically coupling the ECM 626 to a PCB of the electronic device 600. In at least one example, the contact features 640 can include tensioning arms 642(1)-(8). In at least one example, the tensioning arms 642(1)-(8) can be torsion springs, which can twist to allow the contact features 640 to pivot towards the housing sidewall. Additionally or alternatively, the tensioning arms 642(1)-(8) can be configured as linear springs allowing the contact features 640 to be directed towards the housing sidewall. (In some examples, the contact features 642 can include bulges or protrusions. As used herein, a protrusion or a bulge refers to a formation in the ECM 626 that extends towards an internal volume of the electronic device 600 within a planar surface formed by the ECM 626. In some examples, the bulge formation can include a curved, domed, or semi-domed surface facing inward and away from and adjacent housing sidewall toward the conductive member 572 and the PCB of the electronic device 600. In one example, the bulge can be curvilinear. In such examples, the domed or semi-domed, curvilinear nature of the bulge can provide many angled surfaces allowing sufficient contact with the conductive member 572 to form electrical connections within a wide range of assembly and manufacturing tolerances. As depicted in FIG. 6A, the ECM 626 has contact features 640(1)-640(8). However, in other examples, the ECM 626 can have fewer contact features 640 (e.g., between one and seven) or the ECM 626 have more contact features 640 (e.g., greater than eight).

In at least one example, the contact feature 640 includes a tensioning arm 642. The tensioning arm 642 can couple the contact feature 640 between adjacent portions of the ECM 626. The tensioning arm 642 can allow the contact feature 640 to be displaced outward (e.g., toward the sidewall) and/or downward (e.g., away from the display assembly) when the display assembly is disposed within the opening formed by the housing sidewall. In at least one example, a tensioning arm can be a torsion arm or a spring arm, which can exert a restorative force when the display assembly is not disposed within the opening formed by the housing sidewall.

In at least one example, the contact feature 640 extends below (e.g., away from the display assembly) such that a torsion, represented by arrows 629 along the tensioning arm 642(5), is applied to the contact feature 640 and the tensioning arm 642 when the display cover and/or the display assembly is installed. In at least one example, additional contact features (e.g., contact features 320 of FIG. 3), can be welded to the housing sidewall, such that the contact features 640 can be deflected when the display cover and/or the display assembly are installed. In this way, the tensioning arms 642 can allow the contact features 640 to deflect to account for manufacturing tolerances without applying sufficient stress to the contact features (320), which can prevent cracking or damage to the weld points. In at least one example, the welding points can provide grounding of the ECM 626 to the housing sidewall at all contact points of the contact features 320.

FIG. 6B illustrates a first perspective view of a contact feature 640 of the ECM 626 of the electronic device 600, according to one example. Similarly, FIG. 6C illustrates a second perspective view, opposite the first perspective view, of the contact feature 640 of the ECM 626 of the electronic device 600, according to one example.

As depicted, the contact feature 640 can extend away from the ECM 626 and toward the internal volume by a distance represented by 623. The protrusion can extend downward from the tensioning arm 642 by a distance represented by 617. The contact feature 640 can have a profile with an effective diameter between the lengths represented by 619. Thus, by varying the lengths 617, 619, 621, and/or 623, a general shape of the contact feature 640 can be changed. For example, the contact feature 640 can be mound-shaped, pin-shaped, rectangular, ellipsoidal, etc. In the illustrated example of FIGS. 6B and 6C, the protrusion can include a bulge shaped formation/feature including a domed, semi-domed, or curvilinear surface. The side of the contact feature 640 extending away from the ECM 626, as shown in FIG. 6B, can be convex to provide a continuous surface of varying angles. The varying angles of the domed, convex surface of bulge contact feature 640 can provide a range of contact points to make electrical contact with the PCB or conductive portion connected to the PCB of the device within a wide range of manufacturing and assembly tolerances.

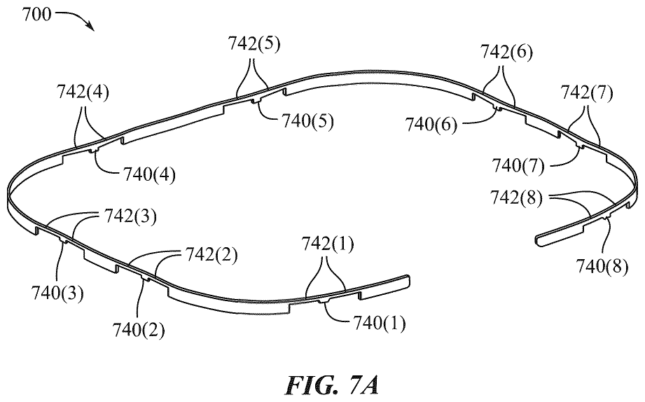

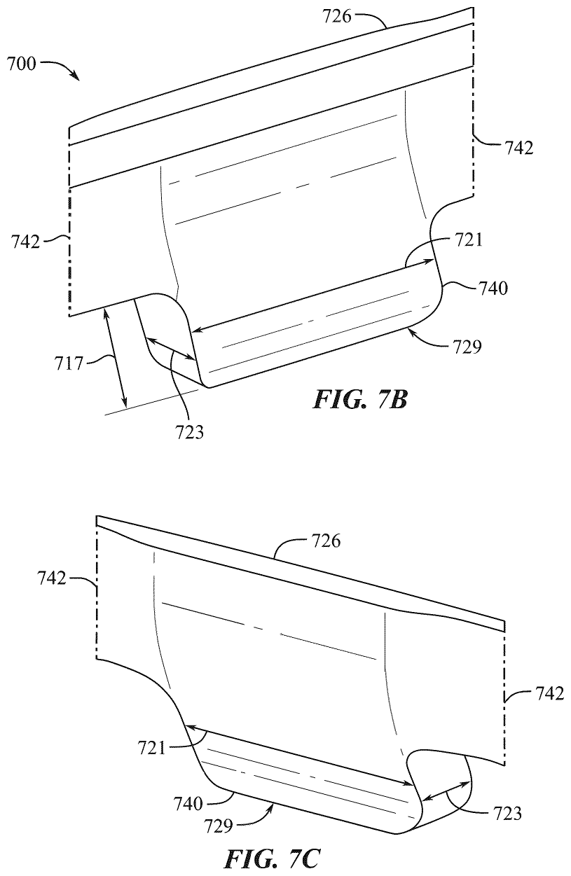

Any of the features, components, and/or parts, including the arrangements and configurations thereof shown in FIGS. 6A-6C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A-6C. Additional details of different types of contact points between the ECM and the PCB are provided below in reference to FIGS. 7A-7C.

FIG. 7A illustrates a portion of an ECM 726 of an electronic device 700, according to one example. Although not all of the components of the electronic device 700 are shown, the electronic device 700 can be similar to the electronic devices 100-600 of FIGS. 1-6, as noted by similar reference numbers.

The ECM 726 includes contact features 740 for electrically coupling the ECM 626 to a PCB of the electronic device 700. The contact feature 740 can be functionally similar to the contact features 640 of FIG. 6, but with a different profile. In at least one example, the contact feature 740 is a protrusion or a flat bulge. As depicted in FIG. 7, the ECM 726 has contact features 740(1)-740(8). However, in other examples, the ECM 726 can have fewer contact features 740 (e.g., between one and seven) or the ECM 726 have more contact features 740 (e.g., greater than eight). In at least one example, the contact feature 740 includes a tensioning arm 742 which is substantially similar to the tensioning arm 642.

FIG. 7B illustrates a first perspective view of a contact feature 740 of the ECM 726 of the electronic device 700, according to one example. Similarly, FIG. 7C illustrates a second perspective view, opposite the first perspective view, of the contact feature 740 of the ECM 726 of the electronic device 700, according to one example.

As depicted, the contact feature 740 can extend away from the ECM 626 and toward the internal volume by a distance represented by 723. The contact feature 740 can extend downward from the tensioning arm 742 by a distance represented by 717. The lower edge 729 of the contact feature 740 can be substantially flat (in two dimensions) or linear (in a one-dimensional projection). A width of the contact feature is illustrated by the arrow 721.

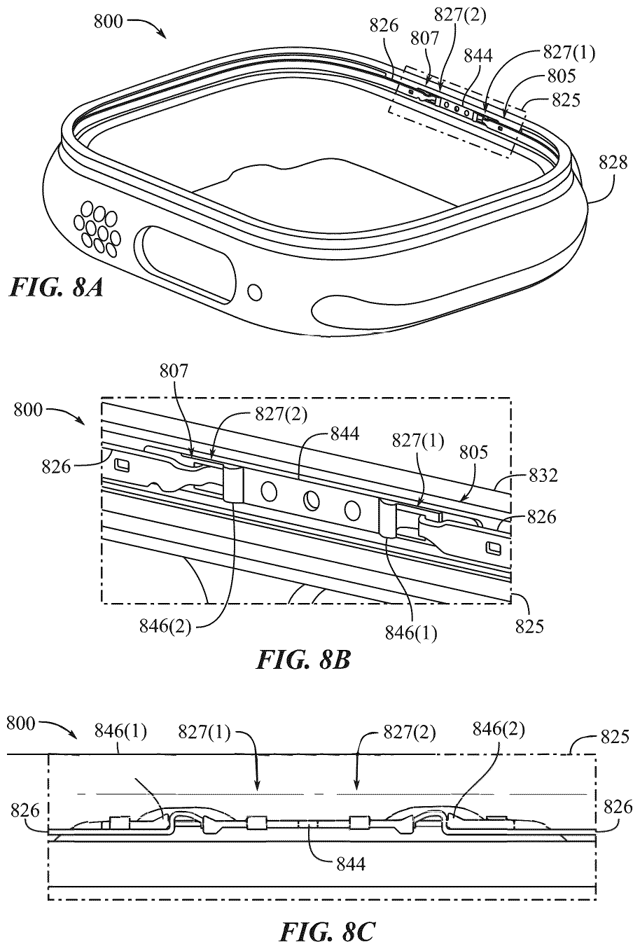

Any of the features, components, and/or parts, including the arrangements and configurations thereof shown in FIGS. 7A-7C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 7A-7C. Additional details of removable coupling between the ECM and the housing are provided below in reference to FIGS. 8A-8C.

FIG. 8A illustrates a perspective view of a portion of an electronic device 800 with a spacer 844 coupling an ECM 826 to a sidewall 828 of a housing of the electronic device, according to one example. Although not all components are necessarily shown, the electronic device 800 can be similar to any of the electronic devices 100-700 of FIGS. 1-7 except that the electronic device 800 includes the spacer 844. As such, the ECM 826 does not need to be welded at a first end 805 or a second end 807 of the ECM 826. In at least one example, the spacer 844 can allow a user of the electronic device 800 to install or replace the ECM 826 without the need for complicated equipment. For example, the user can remove the ECM 826 by hand or with simple and/or inexpensive tools to allow the user to easily repair the ECM 826.

In at least one example, the electronic device 800 includes a conductive housing sidewall 828 defining an internal volume. A PCB (not shown) is disposed in the internal volume. The spacer 844 can be disposed along a first portion (illustrated by 825 and detailed in FIGS. 8B-8C) of an inner perimeter of the conductive housing sidewall 828. A conductive band (e.g., the ECM 826) can be disposed along a second portion of the inner perimeter of the conductive housing sidewall 828. The first end 805 of the ECM 826 can be removably coupled to the conductive housing sidewall 828 at a first position 827(1) along the spacer 844. The second end 807 of the ECM 826 can be removably coupled to the conductive housing sidewall 828 at a second position 827(2) along the spacer 844.

In at least one example, the spacer 844 can be permanently fixed or welded to the conductive housing sidewall 828. The spacer 844 can provide electrical contact between the ECM 826 and the conductive sidewall 828.

FIG. 8B illustrates a zoomed-in perspective view of the region 825 of the electronic device 800, according to one example.

FIG. 8C illustrates a zoomed-in top view of the region 825 of the electronic device 800, according to one example. In at least one example, the first end 805 of the ECM 826 can be mechanically coupled to the spacer 844 at a first position 827(1), and the second end 807 of the ECM 826 can be mechanically coupled to the spacer at a second position 827(2). The spacer 844 can include a first feature 846(1) to receive the first end 805 of the ECM 826. The spacer 844 can include a second feature 846(2) to receive the second end 807 of the ECM 826. In at least one example, the first end 805 and the second end 807 of the ECM 826 can include bends and/or curves, as illustrated, which can allow the first end 805 and the second end 807 to be mated with the first feature 846(1) and the second feature 846(2), respectively, of the spacer 844.

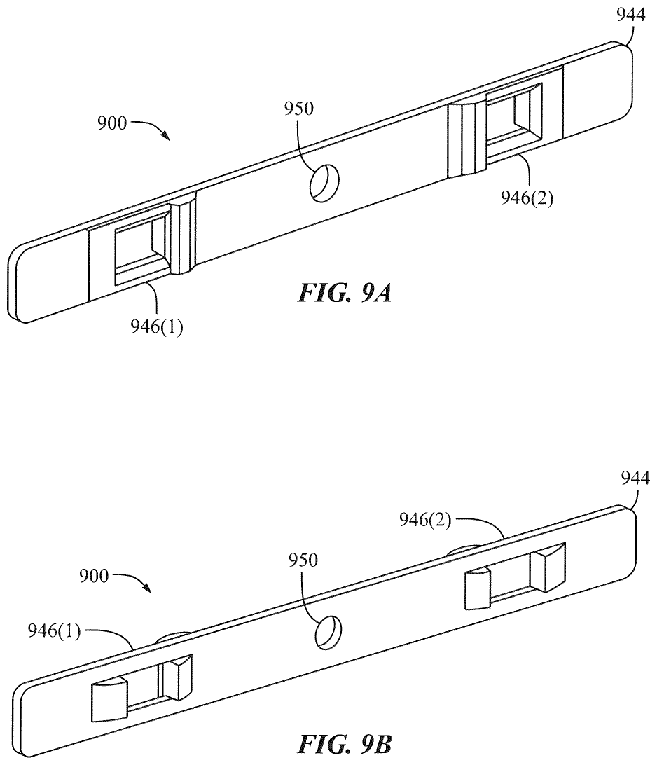

Any of the features, components, and/or parts, including the arrangements and configurations thereof shown in FIGS. 8A-8C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 8A-8C. Additional details of an example spacer are given below in reference to FIGS. 9A-9B.

FIG. 9A illustrates a first perspective view of a spacer 944 of an electronic device 900, according to one example. Similarly, FIG. 9B illustrates a second perspective view, opposite the first perspective view, of the spacer 944 of the electronic device 900, according to one example. Although not all components are necessarily shown, the electronic device 900 can be similar to any of the electronic devices 100-800 of FIGS. 1-8 except that the electronic device 900 includes the spacer 944.

In at least one example, the spacer 944 can include a first feature 946(1) and a second feature 946(2). The first feature 946(1) can be configured to couple with a first end of an ECM (e.g., a wave ring). The second feature 946(2) can be configured to couple with a second end, opposite the first end of the ECM.

In at least one example, the spacer 944 can include a hole 950 which can be a guide hole configured to receive a screw, weld, or other mounting component in order to couple the spacer 944 to the housing sidewall. In at least one example, the hole 950 can be configured to adjustably allow the spacer 944 to be coupled to the housing sidewall. In other words, the spacer 944 can be tightened or loosened against the housing sidewall, the orientation (e.g., the angle of the spacer with respect to the housing sidewall), etc. can be adjusted.

In at least one example, the features 946 of the spacer 944 can include various protrusions facing toward the housing sidewall, toward the internal volume, or a combination thereof. The features 946 can be configured to receive the ends of the ECM. In at least one example, the features 946 can be configured to removably receive the ends of the ECM.

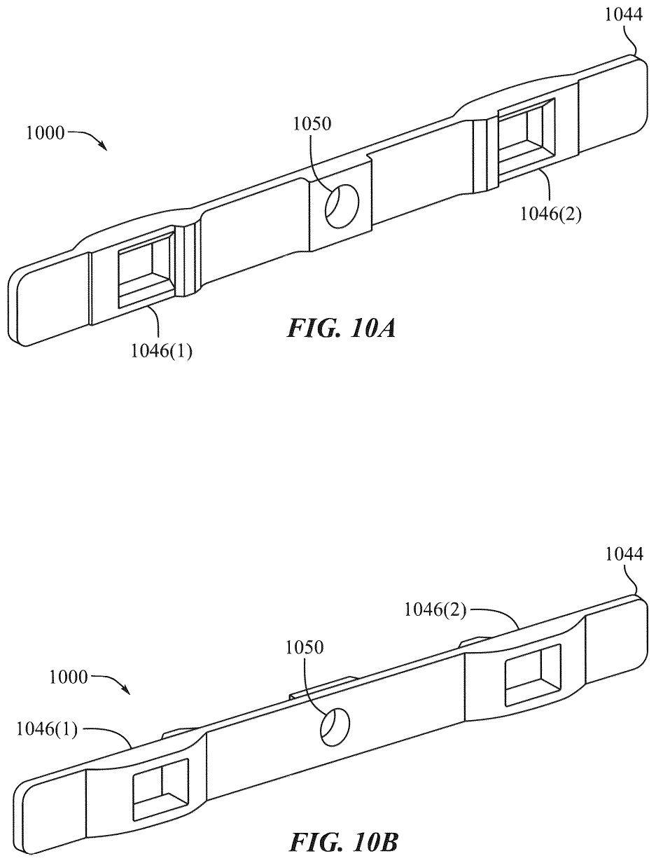

Any of the features, components, and/or parts, including the arrangements and configurations thereof shown in FIGS. 9A-9B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 9A-9B. Additional details of another example spacer are given below in reference to FIGS. 10A-10B.

FIG. 10A illustrates a first perspective view of a spacer 1044 of an electronic device 1000, according to one example. Similarly, FIG. 10B illustrates a second perspective view, opposite the first perspective view, of the spacer 1044 of the electronic device 1000, according to one example. Although not all components are necessarily shown, the electronic device 1000 can be similar to any of the electronic devices 100-900 of FIGS. 1-9 except that the electronic device 1000 includes the spacer 1044. The spacer 1044 can be substantially similar to the spacer 944 of FIG. 9, except with some variations. For example, the spacer 1044 can include additional material at the features 1046(1) and 1046(2) and the hole 1050 which can provide additional mechanical strength to the spacer 1044.

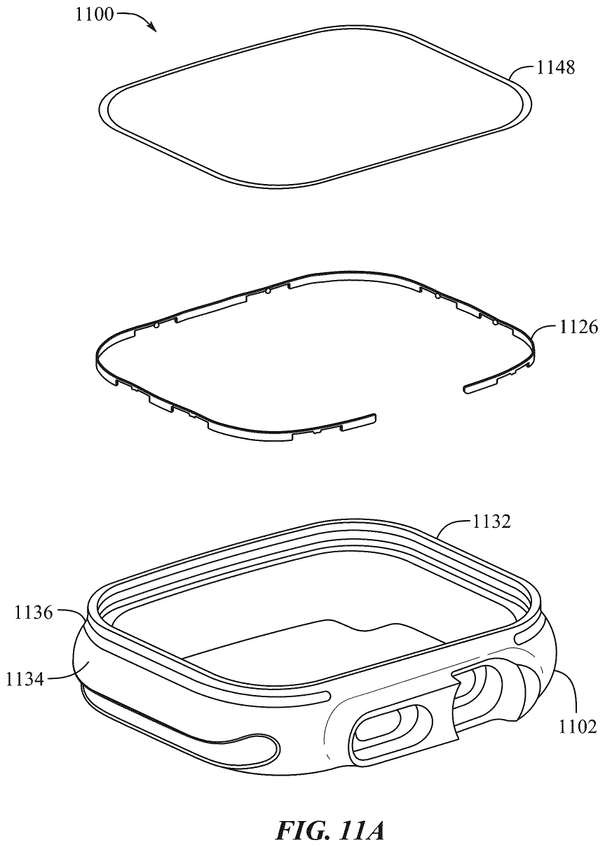

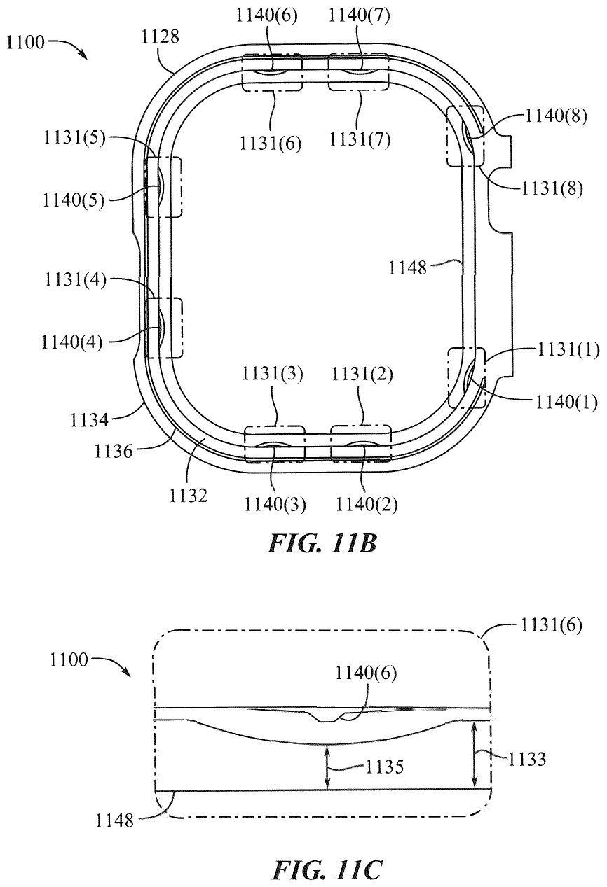

Any of the features, components, and/or parts, including the arrangements and configurations thereof shown in FIGS. 10A-10B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 10A-10B. Details of seal are provided below in reference to FIGS. 11A-11C.

FIG. 11A illustrates an exploded view of an electronic device 1100 including an ECM 1126 and a seal 1148, according to one example. Although not all components are necessarily shown, the electronic device 1100 can be similar to any of the electronic devices 100-1000 of FIGS. 1-10. For example, the ECM 1126 can have any of the contact features and any number of contact features described herein. Furthermore, in at least one example, the seal 1148 can include and/or be similar to the seal 538 of FIG. 5. In other examples, the seal 1148 can be a separate sealant layer that is not illustrated in FIG. 5.

The seal 1148 can be configured to bond other layers and components including various antenna layers, insulating layers, and portions of the sidewall of the housing 1102 to prevent moisture, dust, and/or other contaminants from entering the internal volume of the electronic device 1100. In at least one example, the seal 1148 can be configured to be installed into the housing 1102 after the ECM 1126. As such, the seal 1148 is disposed around the perimeter of the housing between the conductive lower portion 1134 and the display portion (such as display portion 506, not illustrated in FIGS. 11A-11C). The seal 1148 can define depressions or cutouts corresponding to contact features 1140 between the ECM 1126 and the PCB.

In at least one example of the electronic device 100, the housing sidewall 1128 has an upper sidewall portion 1132 and a lower sidewall portion 1134 bonded to a middle sidewall portion 1136 disposed between the upper and lower sidewall portions 1132, 1134, respectively. The housing sidewall 1128 can define an opening 532 and a display assembly (not shown, similar to display assembly 506) can be disposed in the opening 532. Also, in at least one example, the seal 1148 can serve as a seal disposed underneath the display assembly and can be bonded directly to the middle portion 1136 of the sidewall 1128.

The seal 1148 can be a resin or other adhesive. In some examples, the seal 1148 can be substantially resistant to degradation from light, weather, and/or water. In at least one example, the seal 1148 can be an adhesion promotor.

FIG. 11B illustrates a top view of the electronic device 1100 including the seal 1148, according to one example. As shown in FIG. 11B, the seal 1148 can include depressions (e.g., cutouts) 1131. In particular, the seal 1148 can define a cutout 1131 at a first position corresponding to the contact feature 1140.

In at least one example, the cutouts 1131 positionally correspond to locations of contact features (such as the contact features 540-740 of FIGS. 5-7) 1140 electrically contacting the ECM 1126 to the PCB (or an electrically conductive connector). Thus, if there are N contact features 1140(N), there are N cutouts 1131(N). In other examples, the number of contact features 1140(N) and the number of cutouts 11431M) are not the same (e.g., N is different from M). In the example depicted in FIG. 11B, each cutout 1131 corresponds to a contact feature 1140. The contact features 1140 and the cutouts 1131 are distributed along the perimeter of the housing sidewall 1128.

FIG. 11C illustrates a top view of a cutout 1131(6), for example, the cutout 1131(6) in the seal 1148 of the electronic device 1100, according to one example. As depicted in FIG. 11C, the seal 1148 can have a width (as considered within a plane defined by the display assembly) which is narrowest (e.g., thinnest) at a location 1135 corresponding to the contact feature 1140(6). In contrast, at the location 1133, the seal 1148 has its maximum width (e.g., thickness).

In at least one example, the cutouts 1131 are configured to allow the seal 1148 to be installed along the housing sidewall 1128 subsequent to the ECM 1126 being installed. In particular, the cutouts 1131 can be configured to prevent the seal 1148 from interfering with the contact features 1140 of the ECM 1126 during installation of the seal 1148.

Any of the features, components, and/or parts, including the arrangements and configurations thereof shown in FIGS. 11A-11B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 11A-11B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An electronic watch, comprising:
a housing sidewall defining an internal volume;
a printed circuit board (PCB) disposed within the internal volume;
an electrically conductive connector contacting the PCB;
an elongate conductive member disposed along a portion of a perimeter of the housing sidewall, the elongate conductive member comprising:
a first contact feature electrically coupling the elongate conductive member and the electrically conductive connector at a first position along a length of the elongate conductive member, the first contact feature comprising a bulge; and
a second contact feature electrically coupling the elongate conductive member and the housing sidewall at a second location along the length of the elongate conductive member.

2. The electronic watch of claim 1, wherein the bulge extends toward the PCB.

3. The electronic watch of claim 1, wherein the elongate conductive member further comprises:
a third contact feature electrically coupling the elongate conductive member and the electrical connector at a third position along the length of the elongate conductive member; and
a fourth contact feature electrically coupling the elongate conductive member and the housing sidewall at a fourth location along the length of the elongate conductive member.

4. The electronic watch of claim 1, wherein:
the elongate conductive member comprises a first end, and a second end opposite the first end;
the first end and the second end are coupled to the housing sidewall.

5. The electronic watch of claim 4, wherein the elongate conductive member is coupled to the housing sidewall at a third position along the length of the elongate conductive member.

6. The electronic watch of claim 1, wherein the housing sidewall comprises:
a conductive upper portion;
a conductive lower portion; and
an insulating middle portion between the conductive upper portion and the conductive lower portion.

7. The electronic watch of claim 6, wherein:
the electronic watch further comprises an antenna having a radiating element and a grounding element;
the radiating element comprises the conductive upper portion; and
the grounding element comprises the conductive lower portion.

8. The electronic watch of claim 6, wherein:
the conductive upper portion defines an opening;
the electronic watch further comprises a display assembly disposed within the opening; and
the conductive upper portion surrounds a perimeter of the display assembly and extends above the display assembly.

9. The electronic watch of claim 8, further comprising a seal disposed around the perimeter of the housing sidewall between the conductive lower portion and the display assembly, the seal defining a depression at the first position.

10. An antenna assembly, comprising:
a housing defining an internal volume, the housing comprising an upper housing portion and a lower housing portion electrically isolated by a middle housing portion;
a printed circuit board (PCB) disposed within the internal volume;
an elongate conductive member disposed along a portion of an inner perimeter of the upper housing portion, wherein the elongate conductive member comprises:
a first protrusion electrically contacting the PCB at a first location along a length of the elongate conductive member, the first protrusion comprising a tensioning arm; and
a second protrusion contacting the upper housing portion at a second location along the length of the elongate conductive member.

11. Then antenna assembly of claim 10, further comprising an electrically conductive path coupled to the PCB and contacting the first protrusion at the first location.

12. The antenna assembly of claim 10, wherein the first protrusion further comprises a bulge extending toward the PCB and away from the housing.

13. The antenna assembly of claim 10, wherein the first protrusion and the second protrusion extend from the elongate conductive member in opposite directions.

14. The antenna assembly of claim 10, further comprising a seal disposed around a perimeter of a housing and defining a depression corresponding to the first protrusion.

15. The antenna assembly of claim 10, further comprising:
a display module coupled to the PCB and disposed within an opening defined by the upper housing portion, wherein the elongate conductive member is disposed between the upper housing portion and the display module.

16. The antenna assembly of claim 10, further comprising:
a radiating element including the upper housing portion; and
a grounding element including the lower housing portion.

17. An electronic device, comprising:
a conductive housing sidewall defining an internal volume;
a printed circuit board (PCB) disposed within the internal volume;
a spacer disposed along a first portion of an inner perimeter of the conductive housing sidewall;
a conductive band disposed along a second portion of the inner perimeter of the conductive housing sidewall, wherein:
a first end of the conductive band is removably coupled to the conductive housing sidewall at a first position along the spacer; and
a second end of the conductive band is removably coupled to the conductive housing sidewall at a second position along the spacer.

18. The electronic device of claim 17, wherein the spacer comprises:
a first feature to receive the first end of the conductive band; and
a second feature to receive the second end of the conductive band.

19. The electronic device of claim 17, wherein the conductive band comprises:
a first plurality of bulges disposed along a length of the conductive band and forming electrical connections with the PCB; and
a second plurality of bulges disposed along the length of the conductive band and forming electrical connects with the conductive housing sidewall.

20. The electronic device of claim 17, wherein:
the electronic device further comprises an antenna having a radiating element and a grounding element;
the radiating element comprises an upper portion of the conductive housing sidewall; and
the grounding element comprises a lower portion of the conductive housing sidewall.
